(19) United States
(12) Patent Application Publication
(10) Pub. No.: US 2007/0074726 A1
(43) Pub. Date: Apr. 5, 2007

(54) Reusable oxygen cannister with protective cover

(76) Inventor: Michael Peter Majer III, Norridge, IL (US)

Correspondence Address: CHRISTOPHER D. HARRINGTON, SUITE 350, 5300 CORPORATE GROVE SE, GRAND RAPIDS, MI, 49512, US

(21) Appl. No.: 11/240,082

(22) Filed: Oct. 3, 2005

(51) Int. Cl. A62B 19/00; A62B 7/10

(52) U.S. Cl. 128/205.12

(57) ABSTRACT

A novel oxygen supply is disclosed which is a portable oxygen container that comprises a canister, a valve regulator, and a mask, combined to allow the delivery of an oxygen rich airflow to a user upon demand. The portable oxygen container of the present invention includes a refill port for refilling the canister with a supply of gas, and it also includes a protective layer on the exterior of the canister tank in order to cushion the canister tank and prevent damage and/or injury.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to personal oxygen supply systems. More particularly, the present invention relates to a reusable portable oxygen supply that can be used by an athlete or other person in order to revitalize their physical condition when under stress or undue exertion.

Various methods for restoring energy levels have been used by athletes and others who are engaged in strenuous activities. Some approaches are nutritionally based and supply forms of sugar, or electrolytes or other chemistry designed to balance out depleted constituents in the consumer. These products are metabolically based and when ingested it takes considerable time to be fully realized by the user.

It has been known for a long time that oxygen is a prime component in the respiratory process and that exercise of any kind will increase the demand for oxygen in the body and this demand will accumulate and ultimately will restrict the ability of the athlete to recover from the activity in which he/she has been engaged. This phenomenon was observed over time and some methods were developed to supply oxygen to persons like athletes at times when they desire to recover quickly. This occurs many times in professional sports, such as football or basketball, where players have access to oxygen that is usually delivered by a medical quality delivery system. There are many occasions when a sports enthusiast or other people engaged in strenuous activities would like to have oxygen available for the same reasons as the professional athlete.

Attempts to provide a personal oxygen supply are known, including U.S. Pat. No. 4,582,054 (Ferrer) which discloses a pre-packaged pressure container (akin to an aerosol can) that is used with a facemask. This device is a one-time use product meant to be used under conditions where loss of life might be threatened, such as injuries incurred during a fire. Similarly, U.S. Pat. No. 5,123,409 (Sheffield, et al) teaches the use of an oxygen tank that is mounted in an area where it can be used for emergency purposes. The tank is supplied with a specialized valve to regulate pressure and to prevent the passage of liquid. This device, however, is not meant for persistent repeated use nor is it truly portable such that it can be used in different locales. U.S. Pat. No. 5,582,164 (Sanders) is a portable oxygen device for supplying oxygen (or similar gases) to a patient who desires mobility. The oxygen supply in this device is held in coils that can extend and be used to supply the gas to the user. The oxygen is highly pressurized and is meant to provide a sustained supply for normal breathing conditions from anywhere from ½ to 2 hours. Finally, U.S. Pat. No. 4,253,454 (Warncke) teaches the use of a tubular frame for holding a gas like oxygen and for use in conjunction with a re-breather system. It is not meant for the supply of oxygen at a nearly pure state for short repeated bursts.

Notwithstanding the efforts evidenced by the prior art devices, there remains a long-standing need for a portable oxygen apparatus that can be used to supply bursts of an oxygen rich air stream to a user on a repeated basis. The need also exists for a container of this type that can be easily carried and kept for use in different locales, and that can easily be refilled. Examples of the benefits and attributes of the present invention with respect to these long felt problems will be discussed in more detail below.

### SUMMARY OF THE INVENTION

A novel portable oxygen container for use in supplying oxygen gas to a user, comprising a canister for holding the oxygen supply under pressure, a regulator valve, a supply line connected to a mask, and with a mask outlet for dispensing the oxygen into the mask. The oxygen container further includes a refill port for refilling the canister with oxygen.

The portable oxygen container of the present invention also includes a protective layer on the exterior of the canister to protect the canister from direct contact with other objects and also for absorbing condensation that occurs on the outside of the canister when oxygen is being drawn down.

A portable oxygen container of the present invention includes a pressure gage for displaying the condition and quantity of oxygen that is under storage within the canister.

These and other attributes and benefits of the present invention will be disclosed in more detail herein.

### BRIEF DESCRIPTION OF THE DRAWINGS

FIG. 1 is an isometric view of the portable oxygen container shown with the mask installed thereon.

FIG. 2 is an isometric view of the portable oxygen container of FIG. 1 as shown in the opposite direction.

FIG. 3 is a partial cross sectional view of the portable oxygen container showing the interior construction of the canister.

### DETAILED DESCRIPTION OF THE PREFERRED EMBODIMENTS

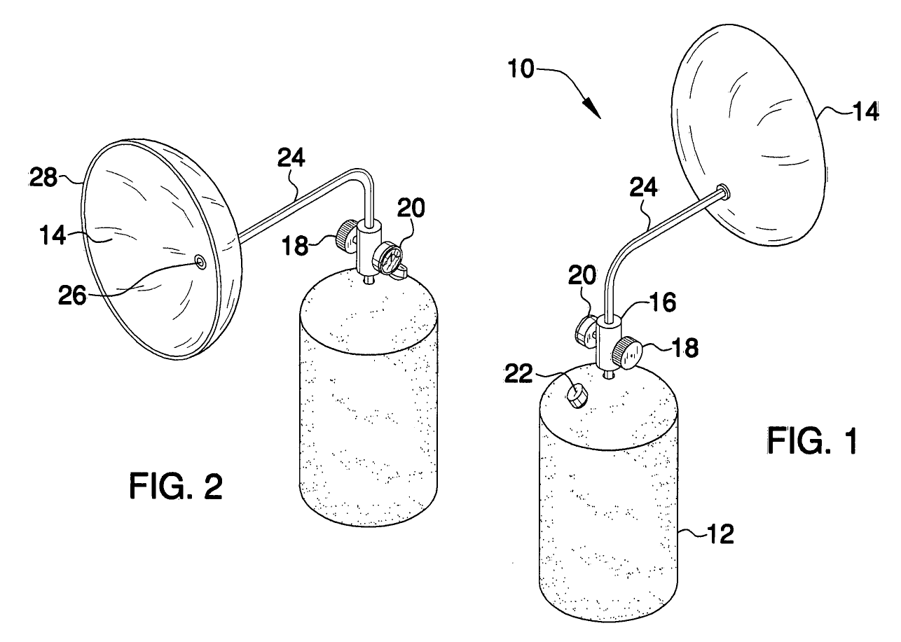

A new portable oxygen container in accordance with the present invention is shown in FIGS. 1, 2 and 3, where a personal oxygen supply 10 includes a canister 12, a mask 14, a valve regulator 16, a valve handle 18, a gage 20, a refill port 22, a supply line 24, a mask outlet 26 and a mask edge 28.

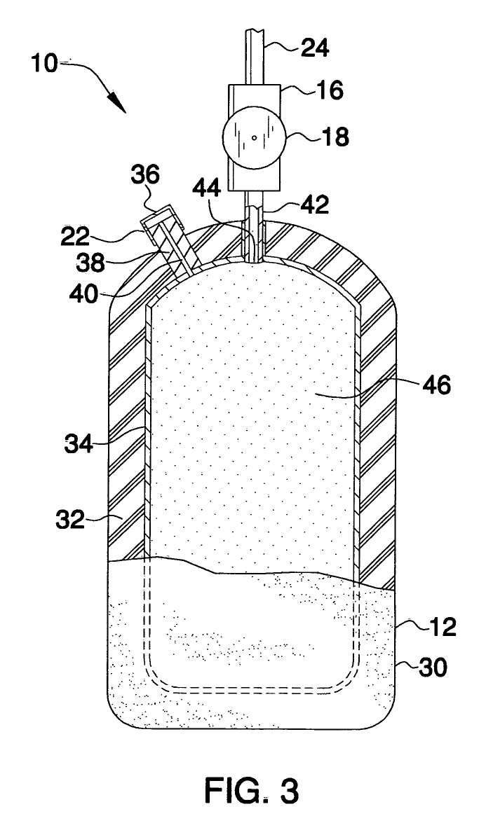

Turning to FIG. 3 in particular, the canister 12 includes a canister exterior 30, a protective layer 32, a canister tank 34, a refill port cap 36, a refill port valve 38, a refill inlet 40, a supply outlet 42, a canister outlet 44 and oxygen gas 46.

The portable oxygen container of the present invention is primarily intended to deliver oxygen rich gas to a user. A mixture of gases may actually be used, however the benefits of supplying oxygen in increased concentration go to the basic thrust of the concept, which is to assist the user in restoring his/her energy and physical state in the quickest possible manner. The usage of oxygen is preferred over the nutritional approaches for the reason that it reaches the bloodstream immediately and it does not create or adjust metabolic conditions like nutritional supplementation does.

The usage of the canister 12 parallels the anticipated volume of oxygen that might be needed. For instance, if the user is climbing mountains, or hiking at altitude, the need for a larger volume would be considered in sizing the canister, however size also means weight and this would be taken in as a factor as well. For sporting events, size is less a consideration since the portable oxygen supply does not have to be carried for long distances.

The canister 12 is fitted with a refill port 22 that includes a connection, refill inlet 40, that extends into the interior of the canister 12. The canister can be taken and refilled from a gas supply company, or it is possible to purchase an oxygen supply that can fill bottles. In any event, the oxygen source has to meet the requirements for human use and not contain oils or other contaminants. Such sources are well known and are left to the user to identify in each locale. Once filled with a supply of oxygen gas (or its equivalent), the portable container is ready for use. When the situation arises, the user merely has to lift the portable oxygen container 10 and position the mask 14 over his face, with the mask edge 28 covering the area around his/her nose and mouth. The face mask encloses the gas being delivered and the mask edge helps to seal the gas flow about the face area, thereby maximizing the concentration being delivered to the user. A turn or more of the valve handle 18 will cause the gas to flow through the supply outlet 42 and through the supply line 24 and out the mask outlet 26. The mask helps to distribute the airflow over the nose and mouth area of the user which makes it an oxygen rich environment if the mask is held properly. It is believed that only a few breaths are needed to substantially alter the oxygen deficits in the users body and restore a measure of vitality.

The benefits of the present invention include the ability to use it in remote places, such as camping, hiking or mountain climbing, as well as places where the locale is more populated and urban or suburban, such as baseball or football games. The size is not overwhelming and would approximate the same size as a regular or large sized propane canister that is commonly available. The oxygen canister though would preferably not contain any fittings that would confuse the user with a propane container and the embodiment as shown has an integral set of components that are fitted to each canister. The portable oxygen container of the present invention would not be able to be fitted or connected to any other gas related apparatus, thereby avoiding the potential for mistakes and possible hazards to occur if used in the wrong application. The refill port is typical of refill ports that are found in other gas supply bottles and is not specifically addressed as part of the present invention except to include refillability as a feature that is important to the use of the preferred embodiment. One-shot containers could be used, but they would become a financial issue for those users who would regularly employ the invention.

The canister is covered with a protective layer 32 that is preferably comprised of a resilient plastic foam. The protective layer cushions the canister should it contact rocks or metal surfaces and it also cushions the user should he/she drop the container on a foot or similar. In use, the draw down of oxygen will cause condensate to form on the surface of the canister tank, and the protective layer can assist in wicking this condensate away from the canister tank and allowing it to migrate to the canister exterior where it will evaporate or drain. The canister exterior may have a cosmetic appearance such as a permeable skin that protects the foam underneath while maintaining the benefits of the protective layer.

The usage of the present invention is not directed towards safety matters, although it could assist in some cases. Unlike canisters set up for supplying oxygen to patients, the present invention does not attempt to meet specific concentrations in the gases being delivered. The use is more blunt, in that the supply of the gas is throttled by the user, allowing more flow when perceived as being needed, and less when less is needed. Ass such, pressure and gas concentrations are not of a concern, nor should they be. This reduces the complexity of the device and allows it to become more portable.

These and other attributes and benefits of the invention would be apparent to one skilled in the art. The teachings herein are meant to illustrate the invention and are not to be taken as limitations on the scope and spirit of the concept.

I claim:

1. A portable oxygen container for the storage and transport of an oxygen rich gas and for the supply of the oxygen rich gas to a user, comprising;
A canister for storing a quantity of gas with at least one fitting for dispensing the gas;
A valve regulator communicating with the canister and for throttling the gas flow;
A supply line for directing the gas flows from the valve regulator; and,
A face mask connected to said supply line for receiving the gas flow and for distributing the gas flow into the face mask, where the face mask includes mask edges which assist to enclose the gas flow about the face of the user thereby providing an oxygen rich atmosphere for the user to breath.

2. The portable oxygen container of claim number 1, where the canister includes a refill port that will allow the refilling of the canister with gas.

3. The portable oxygen container of claim number 1, where the portable oxygen container is sized for personal use and for use in different locales.

4. The portable oxygen container of claim number 1, where the canister further includes a protective layer for cushioning the canister and reducing the potential for damage or injury.

5. A portable oxygen container for the storage and transport of an oxygen rich gas and for the supply of the oxygen rich gas to a user, comprising;
A canister for storing a quantity of gas with at least one fitting for dispensing the gas, the canister further including a protective layer for cushioning the canister and reducing the potential for damage or injury, and also including a refill port that will allow the refilling of the canister with gas;
A valve regulator communicating with the canister and for throttling the gas flow;
A supply line for directing the gas flows from the valve regulator; and,
A face mask connected to said supply line for receiving the gas flow and for distributing the gas flow into the face mask, where the face mask includes mask edges which assist to enclose the gas flow about the face of the user thereby providing an oxygen rich atmosphere for the user to breath.

6. The portable oxygen container of claim number 5, where the fittings are integrally fixed to the canister and are not compatible with connections to any other gas related equipment.

7. The portable oxygen container of claim number 5, where the portable oxygen container is sized for personal use and for use in different locales.

8. A portable oxygen container for the storage and transport of an oxygen rich gas and for the supply of the oxygen rich gas to a user, comprising;
A canister for storing a quantity of gas with at least one fitting for dispensing the gas, the canister further including a protective layer for cushioning the canister and reducing the potential for damage or injury, and also including a refill port that will allow the refilling of the canister with gas;
A valve regulator communicating with the canister and for throttling the gas flow;
A supply line for directing the gas flows from the valve regulator;
A face mask connected to said supply line for receiving the gas flow and for distributing the gas flow into the face mask, where the face mask includes mask edges which assist to enclose the gas flow about the face of the user thereby providing an oxygen rich atmosphere for the user to breath; and,
Where the foregoing components of the portable oxygen container are sized appropriately for personal use and for use in differing locales.

9. The portable oxygen container of claim number 8, where the fittings are integrally fixed to the canister and are not compatible with connections to any other gas related equipment.
